(19) United States
(12) Patent Application Publication
(10) Pub. No.: US 2026/0116801 A1
(43) Pub. Date: Apr. 30, 2026

(54) ORGANIC WASTEWATER TREATMENT APPARATUS AND ORGANIC WASTEWATER TREATMENT METHOD

(71) Applicant: MITSUBISHI KAKOKI KAISHA, LTD., Kangawa (JP)

(72) Inventors: Taira HANAOKA, Kanagawa (JP); Tsuyoshi MAEDA, Kanagawa (JP)

(73) Assignee: MITSUBISHI KAKOKI KAISHA, LTD., Kangawa (JP)

(21) Appl. No.: 19/488,636

(22) PCT Filed: May 30, 2023
(86) PCT No.: PCT/JP2023/020046

§ 371 Date: Nov. 28, 2025

(51) Int. Cl. C02F 9/00; B01D 19/00; C02F 1/20; C02F 3/12; C02F 3/28; C02F 3/30; C02F 101/10; C02F 101/32

(52) U.S. Cl. CPC C02F 9/00; B01D 19/0036; C02F 1/20; C02F 3/1268; C02F 3/2853; C02F 3/307; C02F 2101/10; C02F 2101/32

(57) ABSTRACT

An organic wastewater treatment apparatus includes: a first treatment device configured to perform methane fermentation on organic wastewater containing a floating substance, an organic substance, and a nitrogen component under an anaerobic condition and perform membrane filtration to obtain membrane-filtered water; a second treatment device provided downstream of the first treatment device and including a vacuum degassing device that removes and recovers a part of dissolved methane in the membrane-filtered water; and a third treatment device provided downstream of the second treatment device and configured to perform post-treatment.

### TECHNICAL FIELD

The present invention relates to an organic wastewater treatment apparatus and an organic wastewater treatment method for highly treating organic wastewater and increasing a recovery amount of biogas.

### BACKGROUND ART

Currently, organic wastewater containing organic substances and nitrogen components, such as domestic wastewater, industrial wastewater, sewage, or wastewater obtained by mixing at least one of domestic wastewater, industrial wastewater, sewage (hereinafter, these are collectively and simply referred to as “organic wastewater”), is often treated by a method using aerobic microorganisms represented by an activated sludge method. The activated sludge method is a method of using microorganisms in a state of being floated in water. Activated sludge is produced by blowing air into organic wastewater and stirring the organic wastewater, so that various microorganisms propagate using organic substances in the organic wastewater to form flocs having cohesiveness. The activated sludge contains non-biological inorganic substances and organic substances in addition to microorganisms such as bacteria, protozoa, and metazoan.

Here, sewage treatment (organic wastewater treatment) by the activated sludge method has been put to practical use for about a hundred years, and various methods such as a standard activated sludge method and a circulating nitrification-denitrification method have been developed.

The standard activated sludge method is a technique of treating sewage by a process in which an aeration tank for oxidatively decomposing organic substances in the sewage by activated sludge and a settling tank for separating the activated sludge by gravity are combined with each other.

The circulating nitrification-denitrification method is a technique of biologically removing nitrogen by a method in which a biological reaction tank is disposed in the order of an anoxic tank (denitrification tank) and an aerobic tank (nitrification tank), and a part of a nitrified mixed liquor in the aerobic tank is circulated to the anoxic tank for treatment.

In the activated sludge method in the related art, for example, the above-described circulating nitrification-denitrification method, there are problems that aeration needs to be performed using a large amount of air and power in the aerobic tank (nitrification tank), and a large amount of energy is required, and as a technique for solving this problem, an organic wastewater treatment apparatus including a single-tank type anammox treatment device capable of reducing energy consumption and a generation amount of excess activated sludge has been proposed (Patent Literature 1).

### CITATION LIST

### Patent Literature

Patent Literature 1: JP2019-25438A

### SUMMARY OF INVENTION

### Technical Problem

However, in the technique of Patent Literature 1, when a single-tank type anammox treatment device is installed downstream of a membrane separation methane fermentation tank (anaerobic MBR) mainly for the purpose of removing nitrogen, methane gas is dissolved as biogas in introduced anaerobic membrane-filtered water, and thus there is a problem that the methane gas cannot be efficiently recovered.

That is, when the air aeration treatment is performed on a downstream side in order to oxidize about half the amount of ammonium contained in the anaerobic membrane-filtered water to nitrite nitrogen, dissolved methane is diffused into the atmosphere together with the aeration air, and as a result, methane gas having a high greenhouse effect is released into the atmosphere.

An object of the present invention is to provide an organic wastewater treatment apparatus and an organic wastewater treatment method capable of reducing an amount of methane dissolved in anaerobic membrane-filtered water and increasing a recovery amount of methane when organic wastewater is subjected to anaerobic treatment in a membrane separation methane fermentation tank (anaerobic MBR).

### Solution to Problem

An organic wastewater treatment apparatus according to a first aspect of the present invention, including: a first treatment device configured to perform methane fermentation on organic wastewater containing a floating substance, an organic substance, and a nitrogen component under an anaerobic condition and perform membrane filtration to obtain membrane-filtered water; a second treatment device provided downstream of the first treatment device and including a vacuum degassing device that removes and recovers a part of dissolved methane in the membrane-filtered water; and a third treatment device provided downstream of the second treatment device and configured to perform post-treatment.

An organic wastewater treatment method according to a second aspect of the present invention, including: a first treatment step of performing methane fermentation on organic wastewater containing a floating substance, an organic substance, and a nitrogen component under an anaerobic condition and performing membrane filtration to obtain membrane-filtered water; a second treatment step including a vacuum degassing device that removes and recovers a part of dissolved methane in the membrane-filtered water obtained in the first treatment step; and a third treatment step of performing post-treatment on treated water obtained in the second treatment step.

### Advantageous Effects of Invention

According to the present invention, an amount of dissolved methane in anaerobic membrane-filtered water can be reduced, and a recovery amount of methane as biogas can be increased.

### BRIEF DESCRIPTION OF DRAWINGS

FIG. 1 is a diagram illustrating an outline of an organic wastewater treatment apparatus according to the present embodiment.

FIG. 2A is a schematic configuration diagram of an organic wastewater treatment apparatus according to a first embodiment.

FIG. 2B is a schematic configuration diagram of a second treatment device according to the first embodiment.

FIG. 3 is a schematic configuration diagram of an organic wastewater treatment apparatus according to a second embodiment.

FIG. 4 is a perspective view illustrating a carrier.

FIG. 5 is a schematic configuration diagram of an organic wastewater treatment apparatus according to a third embodiment.

FIG. 6 is a schematic configuration diagram of an organic wastewater treatment apparatus according to a fourth embodiment.

FIG. 7 is a schematic configuration diagram of an organic wastewater treatment apparatus according to a fifth embodiment.

FIG. 8 is a flowchart illustrating contents of an organic wastewater treatment method according to the present embodiment.

FIG. 9 is a flowchart illustrating contents of another organic wastewater treatment method according to the present embodiment.

### DESCRIPTION OF EMBODIMENTS

Hereinafter, the present invention will be described in detail with reference to the drawings. The present invention is not limited to the following embodiments for carrying out the invention (hereinafter, referred to as embodiments). Components in the following embodiments include those that can be easily assumed by those skilled in the art, those that are substantially the same, and those that are in a so-called equivalent scope. Further, the components disclosed in the following embodiments can be appropriately combined.

### [Organic Wastewater Treatment Apparatus]

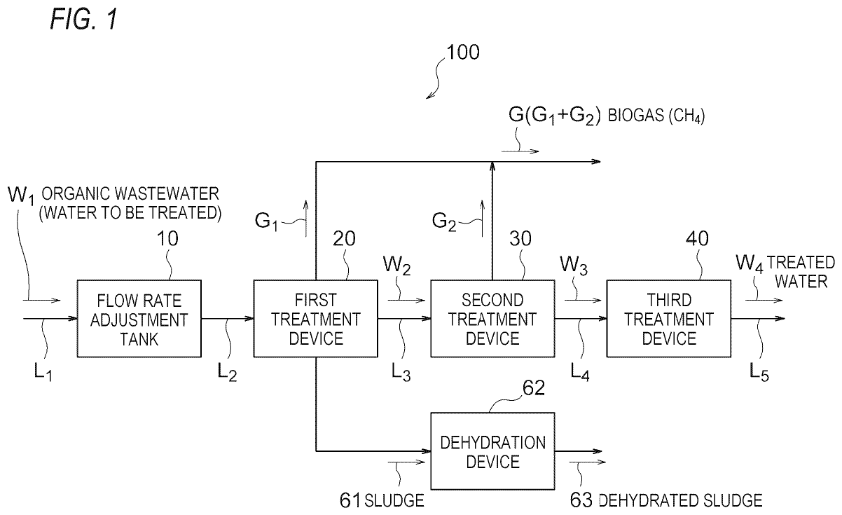

FIG. 1 is a diagram illustrating an outline of an organic wastewater treatment apparatus 100 according to the present embodiment.

The organic wastewater treatment apparatus 100 according to the present embodiment is a device that highly treats organic wastewater W₁ containing an organic substance and a nitrogen component, such as domestic wastewater, industrial wastewater, sewage, or wastewater obtained by mixing at least one of domestic wastewater, industrial wastewater, sewage.

As illustrated in FIG. 1, the organic wastewater treatment apparatus 100 according to the present embodiment includes a first treatment device 20, a second treatment device 30, and a third treatment device 40.

Here, the term “domestic wastewater” refers to, for example, water generated and discharged in general human life such as cooking, washing, and bathing. The term “domestic wastewater” may contain urine and rainwater.

The term “industrial wastewater” refers to wastewater from agricultural, forestry, and fisheries industries (primary industry) and mining industry (secondary industry).

The term “sewage” refers to domestic wastewater added with industrial wastewater or rainwater in some cases. In the present description, leached water from a final landfill site can also be treated as organic wastewater.

The organic substance is also called an organic compound, and refers to a compound constituted based on a covalent bond between carbon atoms.

Examples of the nitrogen component include free ammonium (NH₃), ammonium ion (NH₄⁺), ammonium nitrogen (NH₄—N), nitrite nitrogen (NO₂—N), and nitrate nitrogen (NO₃—N). The term “ammonium nitrogen” refers to nitrogen in the form of ammonium, the term “nitrite nitrogen” refers to nitrogen in the form of nitrite, and the term “nitrate nitrogen” refers to nitrogen in the form of nitrate.

The term “highly treat” refers to removal (denitrification) of the nitrogen component in addition to removal of the organic substance.

Since the organic wastewater treatment apparatus according to the present embodiment includes the parts to be described later, the treatment can be performed regardless of a concentration of the organic substance or a concentration of the nitrogen component in the organic wastewater.

### (Flow Rate Adjustment Tank 10)

In the organic wastewater treatment apparatus 100, a flow rate adjustment tank 10 that adjusts an inflow amount of the organic wastewater W₁ into the first treatment device 20 can be provided upstream of the first treatment device 20. Note that the flow rate adjustment tank 10 can be provided as necessary, and may not be provided.

### First Embodiment

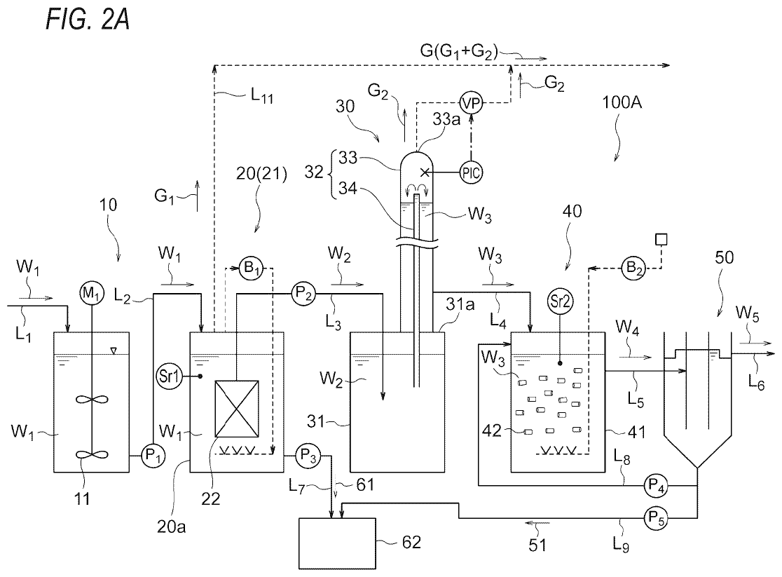

FIG. 2A is a schematic configuration diagram illustrating a configuration of an organic wastewater treatment apparatus 100A according to a first embodiment.

As illustrated in FIG. 2A, the organic wastewater treatment apparatus 100A according to the present embodiment includes the first treatment device 20 that performs methane fermentation on the organic wastewater W₁ containing a floating substance, an organic substance, and a nitrogen component under anaerobic conditions and performs membrane filtration using a microfiltration membrane or an ultrafiltration membrane to obtain membrane-filtered water W₂, the second treatment device 30 that is provided downstream of the first treatment device 20 and includes a vacuum degassing device 32 that removes and recovers a part of dissolved methane in the membrane-filtered water W₂, and the third treatment device 40 that is provided downstream of the second treatment device 30 and performs post-treatment.

The inflow amount of the organic wastewater from the flow rate adjustment tank 10 to the first treatment device 20 can be adjusted by, for example, adjusting an output of a flow rate adjustment tank pump P₁ provided between the flow rate adjustment tank 10 and the first treatment device 20. The inflow of the organic wastewater into the flow rate adjustment tank 10 can be performed by a pump (not illustrated) provided between the flow rate adjustment tank 10 and an organic wastewater treatment facility. The flow rate adjustment tank 10 may include a stirrer 11 that stirs the organic wastewater W₁. The reference numeral M₁ denotes a driving device such as a motor that drives the stirrer 11.

The reference numeral 50 denotes a final settling tank, the reference numeral W₁ denotes organic wastewater, the reference numeral W₂ denotes membrane-filtered water, the reference numeral W₃ denotes methane-removal-treated water, the reference numeral W₄ denotes treated water, the reference numeral W₅ denotes discharge water, the reference numeral L₁ denotes an inflow line, the reference numerals L₂ to L₅ denote drain lines for transferring wastewater or treated water, the reference numerals LU denotes an outflow line, the reference numerals B₁ to B₂ denote blowers, and the reference numerals P₁ to P₅ denote pumps.

### (First Treatment Device 20)

The first treatment device 20 is a device that performs methane fermentation on the organic wastewater W₁ under anaerobic conditions and performs membrane filtration to obtain the membrane-filtered water W₂. That is, most of the organic substance contained in the organic wastewater W₁ can be decomposed by the first treatment device 20, and methane (CH₄) can be produced.

Here, the term “methane fermentation” is a generic term for a decomposition reaction of organic substances by various microorganisms and a methane production reaction in which methanogenic archaea finally produces methane (CH₄).

The generated methane generated in the first treatment device 20 is separately recovered as biogas G₁ via a biogas discharge line L₁₁. The recovered methane is stored in a gas holder (not illustrated) and used for generating electricity and heat. In addition, since membrane filtration is performed, the membrane-filtered water W₂ does not contain a floating substance. The organic substance and the floating substance serve as a generation source of activated sludge in the third treatment device 40. That is, activated sludge is easily generated when denitrifying bacteria are contained in the third treatment device 40. Therefore, it is preferable to decompose or remove the organic substance and the floating substance as much as possible by the first treatment device 20.

Production of methane is performed by the action of the methanogenic archaea. The methanogenic archaea are a generic term for microorganisms that produce methane under anaerobic conditions, and all of them are classified into archaea. The methanogenic archaea produce methane using, as a substrate, hydrogen, carbon dioxide, formic acid, acetic acid, methylamine, or the like produced by completely decomposing organic substances by a plurality of microorganisms under anaerobic conditions. Although a plurality of methane production processes have been proposed, the following two equations (1) and (2) are given as processes that may produce a large amount of methane in nature.

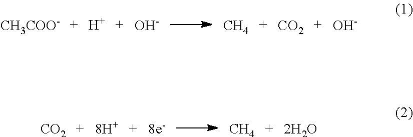

In the present embodiment, hydrogenotrophic methanogenic archaea or aceticlastic methanogenic archaea can be used. Examples of the methanogenic archaea that can be used in the present embodiment include the genus Methanobacterium, the genus Methanobrevibacter, the genus Methanosphaera, the genus Methanothermus, the genus Methanococcus, the genus Methanolacinia, the genus Methanomicrobium, the genus Methanogenium, the genus Methanospirillum, the genus Methanoculleus, the genus Methanoplanus, the genus Methanosarcina, the genus Methanolobus, the genus Methanococcoides, the genus Methanothrix (Methanosaeta), the genus Methanoregula, the genus Methanolinea, the genus Methanohalophilus, the genus Methanohalobium, and the genus Methanocorpusculum. Note that the present embodiment is not limited thereto, and any bacteria that can produce methane can be used. The methanogenic archaea and the above-described various microorganisms that decompose organic substances can be easily obtained from existing digestive tanks and the like.

As the first treatment device 20, a membrane separation methane fermentation tank 20a including a membrane module 22 that performs membrane filtration is preferably used. With such a configuration, the organic wastewater treatment apparatus 100A can be made compact and reduced in construction cost as compared with a device according to an activated sludge method in the related art. In addition, since it is unnecessary to perform aeration with a large amount of oxygen (air) as in the activated sludge method, energy consumption can be reduced, and running cost can be reduced.

The membrane separation methane fermentation tank 20a can be a methane fermentation tank that retains suspended anaerobic bacteria (including methanogenic archaea) or a methane fermentation tank that retains anaerobic granular sludge. The term “suspended anaerobic bacteria” refers to anaerobic bacteria that do not form granules (particulates).

Retaining of the anaerobic bacteria in the former methane fermentation tank can be performed by, for example, simply suspending the anaerobic bacteria in organic wastewater, or adhering and immobilizing the anaerobic bacteria on a gel carrier prepared to have a predetermined size using a polyethylene glycol (PEG)-based prepolymer. Adhering and immobilizing can make fouling to the membrane less likely to occur in membrane filtration.

In addition, the anaerobic granular sludge in the latter methane fermentation tank refers to granular sludge formed by utilizing the property of self-aggregation and granulation of anaerobic bacteria. The granules contained in the anaerobic granular sludge generally refer to granules formed to have a particle size of, for example, 0.2 mm or more, but the present embodiment is not limited thereto, and granules having a particle size of less than 0.2 mm can be treated as granules as long as they form a granulated body. Even in the case of the anaerobic granular sludge, it is possible to make it difficult for fouling to occur in the membrane in membrane filtration.

The anaerobic condition can be created by performing treatment using a tank having a sealed structure into which air does not flow from the outside. In order to set the anaerobic condition, carbon dioxide (CO₂), nitrogen (N₂) gas, or the like may be introduced into a gas phase (headspace) of the tank as necessary. As CO₂ and the N₂ gas to be introduced here, the gas produced by the organic wastewater treatment apparatus 100A can be used.

The membrane filtration can be performed using, for example, at least one of a microfiltration (MF) membrane, an ultrafiltration (UF) membrane, a nanofiltration (NF) membrane, and a reverse osmosis (RO) membrane. In this way, since organic substances having a predetermined size cannot permeate, it is possible to reduce the generation amount of activated sludge in the third treatment device 40 to be described later.

In the present embodiment, among the above, it is preferable to use an MF membrane or a UF membrane. When filtration is performed using an MF membrane or a UF membrane, not only solid organic substances but also organic wastewater (membrane-filtered water) not containing microorganisms such as methanogenic archaea can be supplied to the third treatment device 40 to be described later. That is, by using an MF membrane or a UF membrane, the organic wastewater treatment apparatus 100A can prevent the outflow of the methanogenic archaea from the first treatment device 20 and maintain the number of living cells of the methanogenic archaea in the first treatment device 20 to be high. In the present embodiment, it is more preferable to use an MF membrane having a pore diameter of, for example, 1 μm or less. In this way, power of a membrane filtration pump P₂ used for filtration can be reduced as compared with the case of using an NF membrane or an RO membrane.

The membrane used for membrane filtration may be formed of a chlorinated vinyl resin (CPVC), polyvinylidene fluoride (PVDF), polytetrafluoroethylene (PTFE), or the like. As the form of the membrane used for membrane filtration, a flat membrane, a tubular membrane, or a hollow fiber membrane (tubular membrane having inner diameter of, for example, 5 mm or less, and preferably 3 mm or less) can be adopted.

As the membrane separation methane fermentation tank (anaerobic MBR) used as the first treatment device 20 described above, for example, a cross-flow anaerobic membrane bioreactor (MBR), a (tank separately placed) immersion anaerobic MBR, or an (integrated) immersion anaerobic MBR can be used. FIG. 2A illustrates an (integrated) immersion anaerobic MBR 21.

In the cross-flow anaerobic MBR, a methane fermentation tank for methane fermentation and a membrane separation device for separating sludge with a membrane are independently installed, and membrane filtration is performed by applying a high pressure to inside of a membrane module of the membrane separation device to flow the sludge.

The (tank separately placed) immersion anaerobic MBR and the (integrated) immersion anaerobic MBR 21 perform membrane separation, that is, membrane filtration by suction with the membrane filtration pump P₂. In the (tank separately placed) immersion anaerobic MBR, a methane fermentation tank and a membrane separation device are independently installed, and in the (integrated) immersion anaerobic MBR 21, a membrane separation device is installed in a methane fermentation tank.

In the present embodiment, either of the membrane separation methane fermentation tanks described above may be adopted, but as illustrated in FIG. 2A, the (integrated) immersion anaerobic MBR 21 is preferably adopted. This is because when the (integrated) immersion anaerobic MBR 21 is adopted, the membrane module 22 is accommodated in the tank, so that the installation area is reduced and the device can be made more compact. In addition, when the (integrated) immersion anaerobic MBR 21 is adopted, the number of installed pumps (membrane filtration pumps P₂) can be reduced. Therefore, the organic wastewater treatment apparatus 100 can reduce the construction cost and the running cost, and can further save energy. When the (tank separately placed) immersion anaerobic MBR is adopted, the membrane can be easily washed as compared with the (integrated) immersion anaerobic MBR 21.

When the methane fermentation tank 20a of the membrane separation methane fermentation tank (anaerobic MBR) used as the first treatment device 20 is considered in the form of a biological reactor, wastewater containing a small amount of floating substances contained in organic wastewater can be subjected to a complete mixing method, a fluidized bed method, an anaerobic contact method, or an anaerobic filtration bed method. In addition, when wastewater containing a large amount of floating substances (solid waste) is used, examples of the method include a complete mixing method, an anaerobic contact method, and an anaerobic baffled reactor (ABR) method, but the present invention is not limited thereto.

The first treatment device 20 may be provided with a device (not illustrated) for adding an inorganic salt (metal) such as calcium, magnesium, iron, nickel, cobalt, potassium, sodium, zinc, selenium, tungsten, molybdenum, copper, manganese, or aluminum for the purpose of maintaining the activity of the methanogenic archaea. In addition, the first treatment device 20 can be provided with a heating device (not illustrated) for adjusting a water temperature. The heating device can use heat or electricity obtained by burning the methane gas obtained by the first treatment device 20. The first treatment device 20 can be provided with a sensor Sr1 such as a pH meter, a dissolved carbon dioxide gas meter, or a thermometer. The sensor is individually provided for each measurement target.

### (Second Treatment Device 30)

FIG. 2B is a schematic configuration diagram of the second treatment device. The second treatment device 30 is a methane recovery treatment device provided downstream of the first treatment device 20 and including the vacuum degassing device 32 that removes and recovers a part of the dissolved methane in the membrane-filtered water W₂.

As illustrated in FIG. 2B, the second treatment device 30 includes a second treatment tank 31 into which the membrane-filtered water W₂ flows, and the vacuum degassing device 32.

The vacuum degassing device 32 includes a closing part 31a that closes an upper portion of the second treatment tank 31 to bring the second treatment tank 31 into a sealed state, a degassing outer cylinder (hereinafter, referred to as “outer cylinder”) 33 that is erected in a vertical axis direction on an upper side of the closing part 31a, an inner cylinder 34 having one end 34a disposed in the membrane-filtered water W₂ in the second treatment tank 31 inside the degassing outer cylinder 33 and the other end 34b disposed in an upper gas reservoir S in the degassing outer cylinder 33, and a methane recovery line L₁₂ connected to a top portion of the outer cylinder 33 and having a vacuum pump VP interposed therein. A discharge line IU for transferring methane-removal-treated water W₃ to the third treatment device 40 that performs post-treatment is connected to a side surface of a bottom portion of the outer cylinder 33.

The vacuum pump VP is driven by using the vacuum degassing device 32 to maintain the inside of the gas reservoir S at a predetermined vacuum degree (X), so that the membrane-filtered water W₂ in the second treatment tank 31 is sucked up to rise the inside of the inner cylinder 34, and overflows from the other end 34b of the inner cylinder 34 to fall between the outer cylinder 33 and the inner cylinder 34. At this time, the dissolved methane dissolved in the membrane-filtered water W₂ is subjected to gas-liquid separation as a gas by being depressurized by the vacuum pump VP, and the methane-removal-treated water W₃ from which methane is removed is dropped. The methane-removal-treated water W₃ is sent to the third treatment device 40 from the discharge line L₄ provided on the side surface of the outer cylinder 33. Here, the degassing treatment in the present invention means that the pressure applied to the liquid (membrane-filtered water W₂) is lowered by using the vacuum pump VP, and dissolved gas (methane gas or the like) is subjected to gas-liquid separation and released. The vacuum pump VP is, for example, of a water-sealed type, and the motor is of an explosion-proof type.

Thereafter, the separated and recovered biogas G₂, which is the recovered methane gas, is removed through the methane recovery line L₁₂, and merges with the biogas G₁ on a biogas discharge line L₁₁ side (G=G₁+G₂).

Here, in the present embodiment, the membrane-filtered water obtained by subjecting sewage (inflow water quality: 200 mg/L of BOD, 440 mg/L of COD_{cr}, 200 mg/L of SS, and 33 mg/L of total nitrogen) to methane fermentation treatment at a water temperature of 20° C. using the (integrated) immersion anaerobic MBR as the membrane separation methane fermentation tank is targeted, and when the vacuum degree (VD) in the vacuum degassing device 32 is, for example, 30 kPa (≈0.3 atm), a degassing and recovery ratio of methane dissolved in the membrane-filtered water W₂ is about 75%. In addition, under the condition that the vacuum degree (VD) is, for example, 20 kPa (≈0.2 atm), the degassing and recovery ratio of methane dissolved in the membrane-filtered water W₂ is about 85%.

In addition, in a case where the specific gravity of the membrane-filtered liquid W₂ in the second treatment tank 31 is set to 1.0 and the vacuum degree in the vacuum degassing device 32 is set to, for example, 30 kPa, when a pressure of the upper gas phase section of the second treatment tank 31 is set to the atmospheric pressure, a height (H₁) from a water surface (WL) of the second treatment tank 31 to the other end 34b of the inner cylinder 34 is set to about 7.3 m, so that 75% of the dissolved methane can be recovered. At this time, a height (H₂) of a freeboard part of the upper gas reservoir S is set to about 2 m in consideration of a space for defoaming or the like.

Further, when the pressure of the upper gas phase section of the second treatment tank 31 is set to, for example, 4 kPa, the height (H₁) from the water surface (WL) of the second treatment tank 31 to the other end 34b of the inner cylinder 34 is set to about 7.7 m, so that 75% of the dissolved methane can be recovered. At this time, the height (H₂) of the freeboard part of the upper gas reservoir S is about 2 m.

In addition, in a case where the vacuum degree in the vacuum degassing device 32 is 20 kPa (≈0.2 atm), when the pressure of the upper gas phase section of the second treatment tank 31 is set to the atmospheric pressure, the height (H₁) from the water surface (WL) of the second treatment tank 31 to the other end 34b of the inner cylinder 34 is set to about 8.3 m, so that 85% of dissolved methane can be recovered.

Further, when the pressure of the upper gas phase section of the second treatment tank 31 is set to, for example, 4 kPa, the height (H₁) from the water surface (WL) of the second treatment tank 31 to the other end 34b of the inner cylinder 34 is set to about 8.7 m, so that 85% of the dissolved methane can be recovered.

The pressure (or vacuum) of the vacuum pump VP is regulated by a pressure indication regulator (PIC) provided in an upper gas phase section S of the outer cylinder 33 or the methane recovery line L₁₂.

The height (H₁) from the water surface (WL) of the second treatment tank 31 to the other end 34b of the inner cylinder 34 is appropriately adjusted by, for example, the specific gravity of the membrane-filtered water W₂ in the second treatment tank 31, and, for example, a resistance to a rising flow on an inner surface of the inner cylinder 34.

In this way, a predetermined vacuum degree (for example, 30 kPa) is maintained by the vacuum pump VP, so that the membrane-filtered water W₂ in the second treatment tank 31 is sucked up in vacuum, rises in the inner cylinder 34, overflows from the other end 34b of the inner cylinder 34, and falls between the outer cylinder 33 and the inner cylinder 34. The methane gas, which is the dissolved gas in the membrane-filtered water W₂, is subjected to gas-liquid separation under a reduced pressure in the cylinder and removed. Thereafter, the methane-removal-treated water W₃ from which methane is removed is sent to the third treatment device 40 via the discharge line L₄.

In the present embodiment, the vacuum degree is exemplified as 20 kPa and 30 kPa as preferable examples, but the vacuum degree in the present invention is not limited thereto, and can be, for example, 10 kPa to 50 kPa.

In addition, it is preferable that a rising flow velocity (F₁) of the membrane-filtered water W₂ that rises the inner cylinder 34 is, for example, 0.3 m/sec or less (preferably 0.2 m/sec), and a falling flow velocity (F₂) of the methane-removal-treated water W₃ between the inner cylinder 34 and the outer cylinder 33 is, for example, 0.1 m/sec or less (preferably 0.07 m/sec).

This is because when a falling linear velocity (F₂) is too fast, the methane gas intentionally subjected to the gas-liquid separation is drawn into the falling flow and sent to the downstream third treatment device 40, and the recovery amount of methane is lost, which is to be prevented.

Therefore, a diameter of the outer cylinder, a diameter of the inner cylinder, and a diameter of a gap between the inner cylinder and the outer cylinder are preferably set such that the rising flow velocity (F₁) is, for example, 0.3 m/sec or less and 0.15 m/sec or more, and the falling flow velocity (F₂) is 0.1 m/sec or less and 0.05 m/sec or more.

### (Third Treatment Device 40)

The third treatment device 40 is a post-treatment device that brings the methane-removal-treated water W₃ into a state suitable for discharge regulation in the region, and examples thereof include an anammox treatment device that denitrifies the nitrogen component contained in the methane-removal-treated water by an anaerobic ammonium oxidation reaction, an aeration treatment device that performs aeration treatment on the methane-removal-treated water to increase an oxidation-reduction potential for oxidization and remove a residual BOD component, and a biological membrane filtration treatment device.

In the present embodiment, an anammox treatment device that performs anammox treatment on the methane-removal-treated water W₃ from which methane is removed is installed as the post-treatment device.

Here, the anammox treatment device denitrifies the nitrogen component contained in the methane-removal-treated water W₃ by an anaerobic ammonium oxidation (anammox) reaction. The anammox reaction is a reaction in which anammox bacteria produce N₂ using NH₄—N and NO₂—N as substrates under anaerobic conditions, and the following reaction formula (3) is shown.

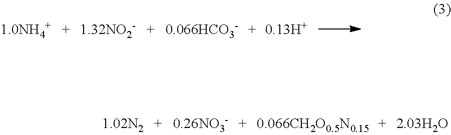

As the anammox bacteria, a bacterium belonging to Kingdom Bacteria, Phylum Planctomycetes, Order Brocadiales, can be used. Since anammox bacteria are not subjected to pure culture at present, “Candidatus” is attached to all phylogenetic classifications. Specific examples of the anammox bacteria that can be used in the present embodiment include Candidatus Brocadia, Candidatus Kuenenia, Candidatus Jettenia, Candidatus Anammoxoglobus, Candidatus Scalindua, and Candidatus Anammoximicrobium. In the present embodiment, the anammox bacteria are not limited to the classification name and the scientific name, and any bacteria can be used as long as they can undergo an anammox reaction. The anammox bacteria can be obtained by using activated sludge or excess activated sludge collected from an existing wastewater treatment device as seed sludge and culturing the seed sludge in a medium containing ammonium nitrogen and nitrite nitrogen or organic wastewater such as sewage for a long period of time. In addition, the anammox bacteria can also be obtained by culturing the above-described seed sludge in an anammox medium having the following composition.

### [Composition of Anammox Medium]

NaNO₂: 0 mg/L to 300 mg/L
NH₄Cl or (NH₄)₂SO₄: 0 mg/L to 300 mg/L
KH₂PO₄: 54 mg/L
KHCO₃: 125 mg/L
Micro Fe/EDTA^{#1}: 1 mL/L
   (Composition of #1: 9 g of FeSO₄·7H₂O, 5 g of EDTA·2Na)

As shown in the reaction formula (3), a molar ratio of NH₄—N and NO₂—N contained in the methane-removal-treated water for the anammox reaction is preferably about 1:1 to 1:1.5, and more preferably about 1:1.32. However, depending on a state of the organic wastewater or the membrane-filtered water as raw water, a content of NH₄—N in the membrane-filtered water is high, but a content of NO₂—N is low in many cases, and the molar ratio is not the same as described above in many cases. Therefore, it is preferable to oxidize a part of NH₄—N contained in the methane-removal-treated water with nitrifying bacteria (ammonium oxidation bacteria) to produce NO₂—N. This is called “partial nitrification” or the like because a part of NH₄—N in the membrane-filtered water is converted into NO₂—N. That is, in the present embodiment, the “anaerobic” ammonium oxidation reaction (anammox reaction) is performed, but the methane-removal-treated water does not need to contain oxygen at all. In the present embodiment, a part of NH₄—N contained in the membrane-filtered water can be made to contain oxygen to an extent necessary for the ammonium oxidation bacteria to convert into NO₂—N. That is, the above “anaerobic” does not mean that the third treatment device 40 is completely in an anaerobic condition, but means that the condition under which the anammox reaction is simply performed (that is, a limited range in which an anammox reaction is performed) may be in an anaerobic condition.

Therefore, when the methane-removal-treated water W₃ in the third treatment device 40 does not contain oxygen sufficient to perform partial nitrification, aeration can be performed using a blower B₂ as illustrated in FIG. 2A. An oxygen concentration of an in-tank liquid in the third treatment device 40 can be measured by a dissolved oxygen meter DOS (not illustrated). In principle, partial nitrification requires only converting about half of NH₄—N to NO₂—N, so that the air amount to be brought into contact can be reduced to about half as compared with a reaction of nitrifying the total amount of NH₄—N to NO₂—N in the activated sludge method in the related art. Therefore, in the present embodiment, when aeration power is used to nitrify NH₄—N to NO₂—N, the required aeration power can be reduced to half as compared with the activated sludge method in the related art. Therefore, the energy consumption such as the amount of electricity in such a case can be reduced to about half.

Examples of the ammonium oxidation bacteria include, but are not limited to, bacteria belonging to the genus Nitrosomonas, the genus Nitrosococcus, the genus Nitrosospira, the genus Nitrosolobus, and the genus Nitrosovibrio.

The production of NO₂—N may be performed in a tank same as the tank in which the anammox reaction is performed, or may be performed in another tank. A tank in which the production of NO₂—N and the anammox reaction are performed in the same tank is referred to as a “single-tank type anammox tank”, and a tank in which the production of NO₂—N and the anammox reaction are performed in different tanks is referred to as a “double-tank type anammox tank”.

In the present embodiment, it is preferable to use a single-tank type anammox tank 41, as illustrated in FIG. 2A. When a single-tank type anammox tank is used, space saving and reduction in construction cost can be implemented as compared with a double-tank type anammox tank (not illustrated).

When a double-tank type anammox tank is used, the anammox bacteria and the ammonium oxidation bacteria can be managed in separate tanks, and thus it is easy to manage each bacterium and control the reaction. In addition, when a double-tank type anammox tank is used, it is possible to adjust the NO₂ concentration and the flow rate of the membrane-filtered water containing NO₂—N produced by ammonium oxidation bacteria and introduce the membrane-filtered water into a tank in which the anammox reaction is performed, and thus it is easy to set the molar ratio between NH₄—N and NO₂—N as described above.

In the anammox reaction, a small amount of NO₃—N is produced. Therefore, the third treatment device 40 preferably contains denitrifying bacteria that reduce the produced NO₃—N to N₂. In this way, most of NH₄⁺ and NH₄—N contained in the organic wastewater can be finally converted into N₂ having no environmental damage by the anammox bacteria and the denitrifying bacteria.

Examples of the denitrifying bacteria that can be used include, but are not limited to, Pseudomonas denitrificans, Pseudomonas aeruginosa, Pseudomonas stutzeri, Pseudomonas mendocina, Comamonas testosteroni, Paracoccus denitrificans, and Alcaligenes faecalis. The treatment with denitrifying bacteria may be performed in a device (tank) different from the third treatment device 40.

The ammonium oxidation bacteria and the denitrifying bacteria can be easily obtained from activated sludge or excess activated sludge collected from an existing wastewater treatment device.

The anammox bacteria and the ammonium oxidation bacteria are autotrophic bacteria that do not use organic substances for proliferation, and thus do not proliferate in large quantity even when soluble organic substances are contained in the methane-removal-treated water. Therefore, in the present embodiment, the production amount of activated sludge derived from the anammox bacteria and the ammonium oxidation bacteria can be reduced.

On the other hand, the denitrifying bacteria are heterotrophic bacteria that convert NO₃—N into N₂ using an organic substance as an electron donor, but proliferate using the organic substance. Therefore, in the present embodiment, although activated sludge derived from the denitrifying bacteria is produced, most of the organic substance has already been decomposed into methane in the first treatment device 20 described above, and the concentration of the organic substance remaining in the methane-removal-treated water is low. Therefore, in the present embodiment, it is possible to reduce the amount of activated sludge produced by growth of the denitrifying bacteria as compared with the activated sludge method in the related art. In addition, in the present embodiment, the growth of heterotrophic bacteria such as denitrifying bacteria is prevented in the third treatment device 40, and thus it is possible to dominate the anammox bacteria. Therefore, the concentration of the anammox bacteria can be increased and an efficient anammox reaction can be performed. In the present embodiment, an organic substance other than methanol may be added to sufficiently convert NO₃⁻ to N₂ by the denitrifying bacteria.

The single-tank type anammox tank 41 preferably includes a carrier 42 formed of a hollow cylinder, which has an inner diameter of, for example, 3 mm to 30 mm, a length of, for example, 3 mm to 30 mm, and opens at both ends.

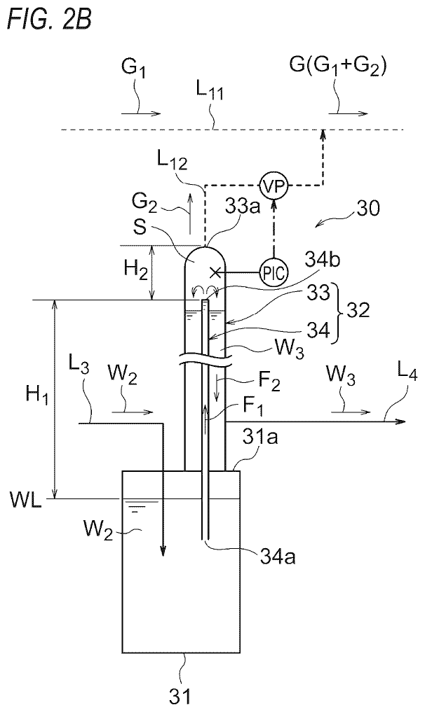

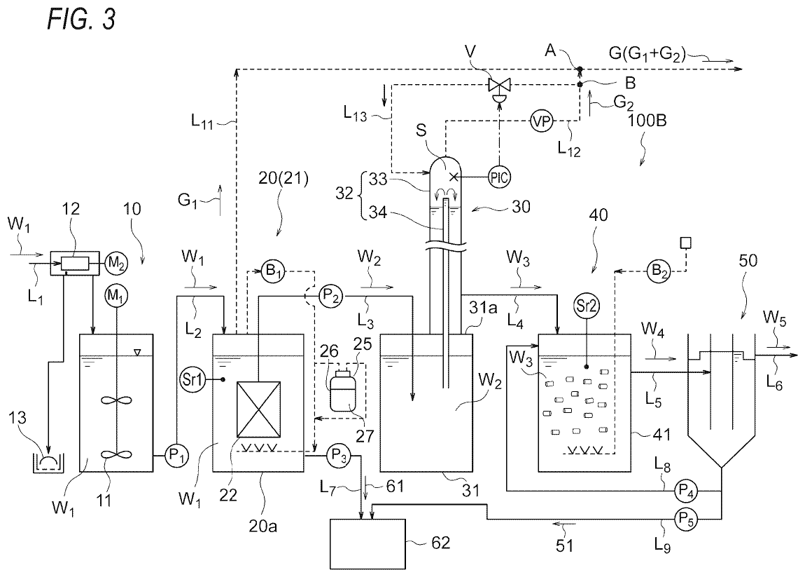

FIG. 3 is a perspective view of the carrier 42. By using such a carrier 42, the ammonium oxidation bacteria are retained on an outer side 42a of the carrier 42, and thus dissolved oxygen derived from air or the like passed through the single-tank type anammox tank 41 is consumed. Therefore, an inner side 42b of the carrier 42 is likely to be under an anaerobic condition. Therefore, the anammox bacteria easily proliferate and are easily retained on the inner side 42b of the carrier 42.

In addition, the inner side 42b of the carrier 42 can be suitably subjected to the anaerobic ammonium oxidation reaction by the anammox bacteria.

In the present embodiment, the carrier 42 of the hollow cylinder preferably has an inner diameter of, for example, 5 mm to 15 mm, and a length of, for example, 5 mm to 15 mm, from the viewpoint of more suitable proliferation and retention of the anammox bacteria and the anaerobic ammonium oxidation reaction by the anammox bacteria.

The hollow cylinder is preferably cylindrical, but may have any shape such as a triangular prism or a quadrangular prism. The carrier 42 can be formed of any resin such as a polypropylene (PP) resin, a polyethylene terephthalate (PET) resin, or a polyvinyl chloride (PVC) resin. An outer diameter of the carrier 42 is not particularly limited. A dosage of the carrier 42 can be set to, for example, 10% to 30%, preferably 20%, in terms of a volume ratio with respect to a volume of the single-tank type anammox tank 41, but is not limited thereto.

In addition, in the single-tank type anammox tank 41 into which the carrier 42 is charged, the in-tank liquid to which the membrane-filtered water is supplied is stirred by at least one device of air blowing and mechanical stirring, and it is preferable that the dissolved oxygen concentration of the in-tank liquid is controlled to, for example, 0.5 mg/L or less. In this way, it is possible to supply O₂ at an appropriate concentration from a necessary minimum to the ammonium oxidation bacteria retained on the outer side of the carrier 42, and to perform partial nitrification. In addition, as described above, in the present embodiment, O₂ is consumed by the ammonium oxidation bacteria retained on the surface of the carrier 42. Therefore, in the present embodiment, anaerobic conditions can be maintained for the anammox bacteria retained on the inner side 42b of the carrier 42, and the anammox reaction can be performed. That is, when the dissolved oxygen concentration is controlled as described above, the partial nitrification by the ammonium oxidation bacteria can be performed without significantly affecting the anammox reaction by the anammox bacteria. It is more preferable that the dissolved oxygen concentration of the in-tank liquid is controlled to 0.3 mg/L or less in order to more reliably exert the above-described effect.

The third treatment device 40 may be provided with a device (not illustrated) for adding an inorganic salt (metal) such as calcium, magnesium, iron, nickel, cobalt, potassium, sodium, zinc, selenium, tungsten, molybdenum, copper, manganese, or aluminum for the purpose of maintaining the activity of the anammox bacteria, the ammonium oxidation bacteria, the denitrifying bacteria, or the like.

In addition, the third treatment device 40 can be provided with a heating device (not illustrated) for adjusting a water temperature. The heating device can use heat or electricity obtained by burning the methane gas obtained by the first treatment device 20. The third treatment device 40 can be provided with various sensors Sr2 such as a pH meter, a dissolved oxygen meter DOS, an ammonium sensor, a nitric acid sensor, and a thermometer. Although the sensors are individually provided for each measurement target, only one sensor is illustrated in FIG. 2A for the purpose of illustration.

A final settling tank 50 is installed downstream of the third treatment device 40, and the resultant was finally precipitated and discharged to the outside as discharge water W₅. A sludge return pump P₄ for returning sludge to the third treatment device 40 is interposed from the bottom portion of the final settling tank 50.

As a nitrogen removal device of the third treatment device 40, an anammox treatment device is exemplified, but the present invention is not limited thereto. Examples of other sewage treatment methods include, but are not limited to, a standard activated sludge method, a circulating nitrification-denitrification method, a circulation nitrification/denitrifying membrane bioreactor, an anaerobic/aerobic activated sludge method, and an anaerobic-oxygen-free-aerobic method.

### Test Example

Calculation is performed using sewage (inflow water quality: 200 mg/L of BOD, 440 mg/L of COD_{Cr}, 200 mg/L of SS, 33 mg/L of total nitrogen) being treated, at 4,000 m³/day in terms of treatment amount, using the organic wastewater treatment apparatus 100A at each of water temperatures of 17° C. 20° C., and 25° C. The unit power consumption is 0.4 kWh/m³. The results are shown in Table 1 below.

TABLE 1

| | Anaerobic MBR + anammox treatment | | |
|---|---|---|---|
| | 17° C. | 20° C. | 25° C. |
| Unit power consumption | 0.4 | 0.4 | 0.4 |
| (kWh/m³) | | | |
| I methane generation | 190 | 240 | 310 |
| amount (Nm³-CH₄/day) | | | |
| II methane recovery | 80 | 75 | 70 |
| amount (Nm³-CH₄/day) | | | |
| Total amount of | 270 | 315 | 380 |
| methane (Nm³-CH₄/day) | | | |

As shown in [Table 1], when the vacuum degassing device as in the related art is not installed, the biogas G₁ (I “methane generation amount (Nm³-CH/day)”) as the methane generation gas is 190 Nm³-CH₄/day at 17° C., 240 Nm³-CH/day at 20° C., and 310 Nm³-CH/day at 25° C.

On the other hand, when the second treatment tank 31 including the vacuum degassing device 32 is installed, the methane recovery gas G₂ (II “methane recovery amount (Nm³-CH₄/day)”) is 80 Nm³-CH₄/day at 17° C., 75 Nm³-CH₄/day at 20° C., and 70 Nm³-CH₄/day at 25° C.

As a result, as shown in Table 1, when the (II) methane recovery amount is added to the (I) methane generation amount, the total amount of methane is 270 Nm³-CH₄/day at 17° C., 315 Nm³-CH₄/day at 20° C., and 380 Nm³-CH₄/day at 25° C.

When the temperature is high, the methane recovery amount is small because the amount of dissolved methane in the first treatment device is small.

It is confirmed from the above that when the second treatment tank 31 including the vacuum degassing device 32 is installed, the dissolved methane in the first treatment device is efficiently recovered, and the total recovery amount of methane can be increased.

Since the solubility of methane is increased when the temperature is low (17° C.), the amount of dissolved methane is increased as compared with the case where the temperature is high (25° C.), and thus the recovery amount is increased (80 Nm-CH₄/day).

### Second Embodiment

FIG. 3 is a schematic configuration diagram illustrating a configuration of an organic wastewater treatment apparatus 100B according to the first embodiment. Members having the same configurations as those of the first embodiment are denoted by the same reference numerals, and redundant description thereof will be omitted.

As illustrated in FIG. 3, the organic wastewater treatment apparatus 100B according to the present embodiment is obtained by further providing, in the organic wastewater treatment apparatus 100A according to the first embodiment, a drum screen 12 having a predetermined opening (for example, 0.5 mm to 1.0 mm) as a removal device for removing a solid content in the organic wastewater W₁ to be introduced into the flow rate adjustment tank 10. Separated sediment 13 is separately treated. In addition, in the present embodiment, a grit chamber (not illustrated) for precipitating and removing earth and sand in organic wastewater can be provided upstream of the flow rate adjustment tank 10. The reference numeral M₂ denotes a driving device such as a motor for driving the drum screen 12.

As illustrated in FIG. 3, the first treatment device 20 is provided with a fourth treatment device 25 that removes CO₂ generated by methane fermentation of the first treatment device 20. For example, when organic wastewater having a low concentration of an organic substance and a nitrogen component, such as domestic wastewater, is subjected to methane fermentation to generate CO₂, the pH of the organic wastewater may decrease, but such a possibility can be prevented by providing the fourth treatment device 25 described above to remove CO₂ at all times or in a timely manner. That is, since CO₂ is removed by the fourth treatment device 25, the pH of the organic wastewater can be less likely to decrease. Therefore, it is easy to adjust the pH of the obtained membrane-filtered water W₂ to the range of pH of 7 to 8.5 suitable for the anammox reaction to be performed in the downstream third treatment device 40. There is also organic wastewater having a high concentration of an organic substances and a low concentration of a nitrogen component (NH₄—N), but the same effect can also be exerted in such organic wastewater.

For example, as illustrated in FIG. 3, the fourth treatment device 25 may be a CO₂ removal device that is connected to a membrane cleaning blower B₁ for preventing fouling on a membrane by circulating gas in the headspace of the fourth treatment device 25, uses a container 26 having a predetermined size and containing water 27 therein, and absorbs and removes CO₂ in the water 27.

In the case of a large device, for example, it is possible to adopt a device in which a shelf continuous absorption tower is used, biogas generated by methane fermentation flows in an upward flow and water is sprinkled in a downward flow to cause gas-liquid contact, so that CO₂ in the biogas is absorbed in water and thus removed. In addition, a packed column type device using granular slaked lime as a CO₂ removing agent can be adopted.

In addition, as the fourth treatment device 25, for example, a discharge mechanism (not illustrated) that removes CO₂ by discharging CO₂ to the outside of the device may be used. Examples of such a discharge mechanism include a CO₂ permselective membrane (facilitated transport membrane). Examples of the CO₂ permselective membrane include a dendrimer membrane (dendritic polymer membrane having structure regularly branched from center) prepared using polyethylene glycol (PEG), polyvinyl alcohol (PVA), polyamide amine (PAMAM), or the like. When such a CO₂ permselective membrane is used, transportation of CO₂ from the tank may be promoted using a suction pump.

The fourth treatment device 25 is not limited to that described above, and any device can be used as long as CO₂ can be removed.

In addition, as in the organic wastewater treatment apparatus 100B according to another embodiment illustrated in FIG. 3, a gas return line L₁₃ for returning the recovered methane into the upper gas reservoir S in the outer cylinder 33 is provided upstream of a merging part A where the biogas line Ln and the methane recovery line L₁₂ for recovering the methane gas removed from the second treatment tank 31 merge. Further, when the vacuum degree (X) of the vacuum pump VP is higher than a predetermined set value (for example, 30 kPa), that is, when an internal pressure is low, a switching valve V is adjusted to perform so-called “spill-back control” of recycling through the line L₁₃ in the upper gas reservoir S in the outer cylinder 33.

In addition, when the vacuum degree is low, that is, the internal pressure is high, the spill-back control is not performed, the switching valve V is adjusted, and the vacuum pump VP is controlled to exhaust the gas in the system to a line L₁ side through the line L₁₂.

On the other hand, when the vacuum degree (X) of the vacuum pump VP exceeds 30 kPa, determination is performed by the PIC, the valve V is switched, and the methane gas G₂ is discharged to the biogas discharge line L₁₁ side without being recycled, mixed with the biogas G₁, and discharged as biogas G (G₁+G₂).

For example, a check valve is installed between a branch B and the merging part A of the methane recovery line L₁₂, and a pressure on a discharge side is set to a pressure P₁ (for example, 4 kPa) of the gas phase section of the first treatment device 20.

For example, a desulfurization tower may be installed in the biogas discharge line Lu to remove hydrogen sulfide in the gas. Accordingly, corrosion of the gas holder is prevented.

In the present embodiment, one vacuum degassing device 32 is provided, but the present invention is not limited thereto, and a plurality of vacuum degassing devices 32 may be provided. In this case, the vacuum degree is preferably increased toward the downstream side.

In particular, when the organic wastewater contains a substance that easily foams, it is necessary to reduce the vacuum degree, and thus it is preferable to provide a plurality of vacuum degassing devices.

In addition, a plurality of inner cylinders 34 may be disposed inside one outer cylinder 33.

Further, a plurality of second treatment devices 30 (30-1, 30-2 to 30-n) may be provided.

At this time, the vacuum degree is appropriate changed to be suitable for the case of foaming by the target treated water.

### Third Embodiment

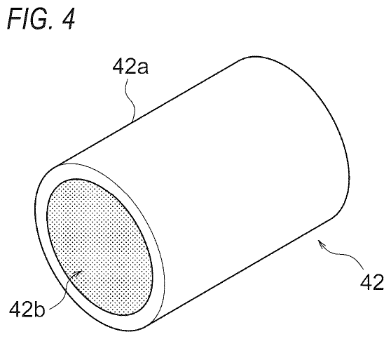

FIG. 5 is a schematic configuration diagram illustrating a configuration of an organic wastewater treatment apparatus 100C according to a third embodiment.

As illustrated in FIG. 5, the organic wastewater treatment apparatus 100C uses an integrated tank 71 common to the tanks of the first treatment device 20 and the second treatment device 30 in the first and second embodiments. A partition wall 72 is provided inside the integrated tank 71 to separate the organic wastewater W₁ from the membrane-filtered water W₂. By providing the integrated tank 71, it is unnecessary to provide two tanks, and the treatment device may be simplified.

In addition, in order to recover methane as biogas from the gas phase section of the first treatment device 20, a blower B₃ is installed in the biogas discharge line Lu, a blower discharge pressure thereof is set to, for example, 2 KPa to 4 KPa, and generated methane G₁ from the organic wastewater W₁ generated by methane fermentation is recovered. The vacuum pump VP₁ of the methane recovery line L₁₂ recovers the methane gas from the membrane-filtered water W₂ at a predetermined vacuum degree (for example, 30 kPa or 20 kPa) similar to or same as described above.

That is, in a case where the first treatment device 20 described in the first embodiment is an independent tank, the pressure P₁ (for example, 4 kPa) of the gas phase section is normally maintained at a slight positive pressure (for example, 4 kPa) in order to prevent intrusion of air and secure anaerobic conditions, and the biogas (methane) G₁ is pushed into, for example, a desulfurization tower or a gas holder installed downstream of the biogas line L₁ by maintaining the pressure. Therefore, it is also necessary to maintain the pressure of the gas phase section at a slight positive pressure (normally, 4 kPa) in the integrated tank 71 obtained by integrating the tanks of the first treatment device 20 and the second treatment device 30 described above, as in the present embodiment. Therefore, the third blower B₃ is installed in the biogas discharge line L₁₁, and the discharge pressure thereof is changed to, for example, 4 kPa or more to recover the generated methane G₁.

In the present embodiment, 4 kPa is exemplified as the pressure of the slight positive pressure of the gas phase section of first treatment device 20, but the pressure of the gas phase section in the present invention is not limited thereto, and can be, for example, 2 kPa or more and 10 kPa or less, and more preferably 4 kPa or more and 5 kPa or less.

### Fourth Embodiment

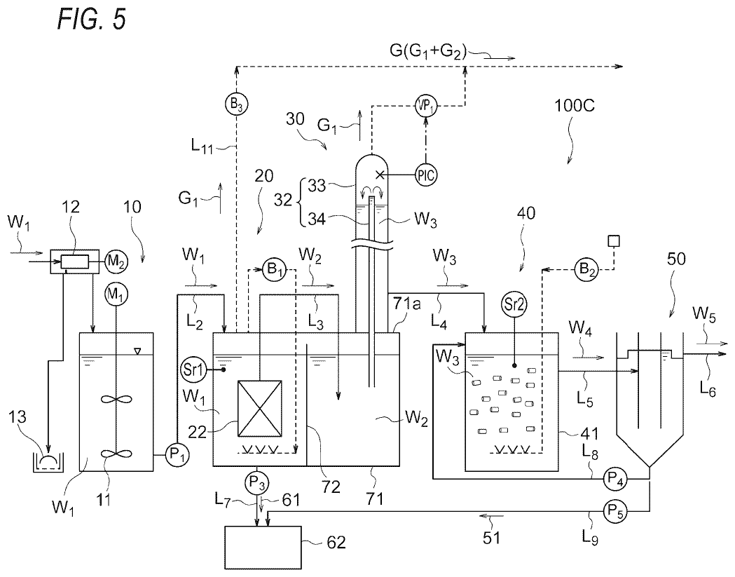

FIG. 6 is a schematic configuration diagram illustrating a configuration of an organic wastewater treatment apparatus 100D according to a fourth embodiment.

As illustrated in FIG. 6, the organic wastewater treatment apparatus 100D is provided with a simple aeration tank 43. When there is no regulation of nitrogen, the reaeration tank 43 for simple aeration can be installed without providing a treatment device for the anammox tank 41.

### Fifth Embodiment

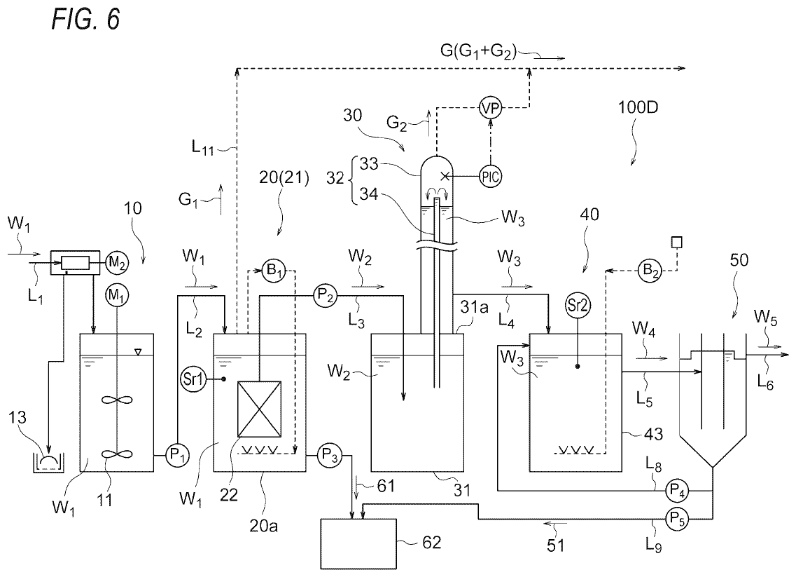

FIG. 7 is a schematic configuration diagram illustrating a configuration of an organic wastewater treatment apparatus 100E according to a fifth embodiment.

As illustrated in FIG. 7, the organic wastewater treatment apparatus 100E is a treatment method in which the final settling tank 50 as in the first to fourth embodiments is not installed.

A biological membrane filtration device 80 is installed as the third treatment device. A filling layer 81 is disposed inside the biological membrane filtration device 80. As the filling layer 81, for example, a molded product of a natural material such as crushed stone or various plastics is used. A ceiling part 80a of the biological membrane filtration device 80 has a structure with a covered lid to prevent the methane-removal-treated water from being released and thus diffused to the atmosphere. In the present embodiment, the methane-removal-treated water W₃ is supplied to either an upper gas phase section in the biological membrane filtration device 80 or an upper liquid phase of a biological-membrane-attached filter medium.

The third treatment device 40 may be provided with a settling zone (not illustrated) for precipitating excess activated sludge at a subsequent stage of the treatment in the tank. Note that this settling zone can be freely provided, and may not be provided. The settling zone can be provided by dividing inside of the tank with a metal fence or the like having an opening that does not allow the carrier 42 to pass therethrough. When this settling zone is provided, the settling tank can be omitted.

### (Other Facilities in Organic Wastewater Treatment Apparatus)

As illustrated in FIGS. 1 and 2A, the organic wastewater treatment apparatus 100 according to the present embodiment may include a dehydration device 62 that dehydrates sludge 61 collected from the first treatment device 20 into dehydrated sludge 63. As the dehydration device 62, for example, a centrifuge, a belt press dehydration device, or a screw press dehydration device can be used. The dehydrated sludge dehydrated by the dehydration device 62 is carried out and appropriately treated, for example, by being incinerated or used for landfill in the final landfill site. As illustrated in FIG. 2A, conveyance of the sludge from the first treatment device 20 to the dehydration device 62 can be performed by a pump (not illustrated) provided therebetween.

As illustrated in FIG. 2A, the final settling tank 50 for settling and separating the sludge in the treated water treated by the third treatment device 40, separating the sludge into settled sludge and water with clean supernatant (treated water), and discharging the clean water (treated water) may be provided downstream of the third treatment device 40. The settling tank 50 also has a function of storing the treated water.

In addition, the biogas discharge line Ln for discharging the biogas (methane) G₁ generated from the first treatment device 20 to the outside can be provided with a water sealing device (not illustrated) for preventing inflow of air from an opening end of the gas pipe. Further, the biogas discharge line Ln may be provided with a gas meter (not illustrated) for measuring the generation amount of biogas. In addition, the gas pipe may be provided with a desulfurization tower (not illustrated) for removing hydrogen sulfide contained in the biogas G₁. Commercially available water sealing devices, gas meters, and desulfurization towers can be used.

Since the organic wastewater treatment apparatus 100 according to the present embodiment includes the first treatment device 20 and the third treatment device 40 even when the flow rate adjustment tank 10, the dehydration device 62, and the like are provided, the device installation area, the cost, and the like can be reduced as compared with a device using the activated sludge method in the related art (for example, circulating nitrification-denitrification method).

As described above, the organic wastewater treatment apparatuses 100A to 100E according to the present embodiment described above can obtain membrane-filtered water by performing methane fermentation of an organic substance and membrane filtration in the first treatment device 20. Since the organic substance is decomposed by methane fermentation into methane and CO₂, a concentration of the organic substance contained in the membrane-filtered water W₂ can be reduced. Almost all of the organic substance contained in the membrane-filtered water W₂ is soluble. In addition, since filtration is performed by membrane filtration, there is no floating substance contained.

In addition, since dissolved methane in first treated water (membrane-filtered water W₂) from the first treatment device 20 is recovered by the vacuum degassing device of the second treatment device, the recovery amount of biogas can be increased.

### [Organic Wastewater Treatment Method]

Next, the organic wastewater treatment method according to the present embodiment will be described.

The organic wastewater treatment method according to the present embodiment is a method of highly treating organic wastewater containing an organic substance and a nitrogen component, such as domestic wastewater, industrial wastewater, sewage, or wastewater obtained by mixing at least one of domestic wastewater, industrial wastewater, sewage. Since the organic wastewater treatment method according to the present embodiment can be suitably performed by the organic wastewater treatment apparatuses 100A to 100E according to the present embodiment described above, the organic wastewater treatment apparatus 100A will be described below as an example. Therefore, components common to the organic wastewater treatment method according to the present embodiment and the organic wastewater treatment apparatus 100A according to the present embodiment are denoted by the same reference numerals, and detailed description thereof will be omitted.

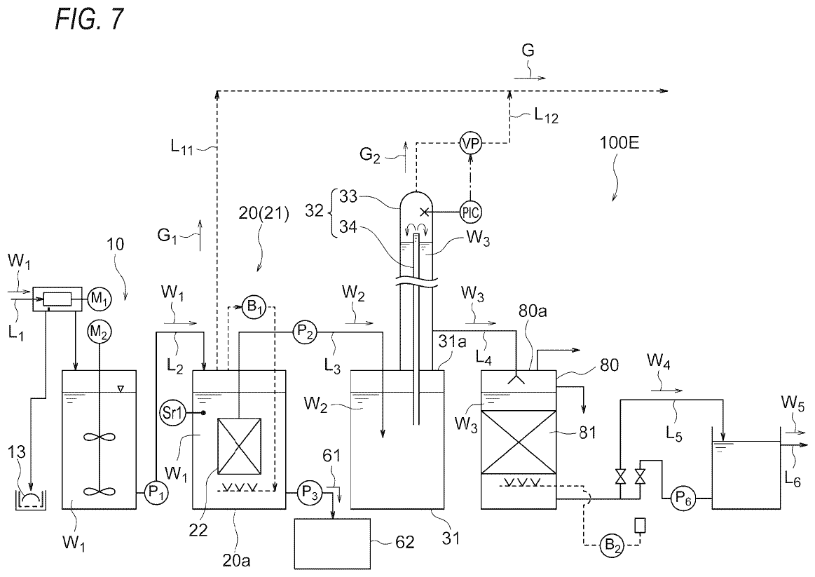

FIG. 8 is a flowchart illustrating contents of the organic wastewater treatment method according to the present embodiment. As illustrated in FIG. 8, the organic wastewater treatment method according to the present embodiment includes a first treatment step S11, a second treatment step S12, and a third treatment step S13, and these steps are performed in this order.

### (First Treatment Step S11)

The first treatment step S11 is a step of subjecting the above-described organic wastewater to methane fermentation under anaerobic conditions and membrane filtration to obtain membrane-filtered water. The first treatment step S11 can be performed by the first treatment device 20 in the organic wastewater treatment apparatus 100. Therefore, the membrane-filtered water W₂ obtained by the treatment in the first treatment step S11 has a low concentration of organic substances and does not contain floating substances. Therefore, in the subsequent third treatment step S13, the generation amount of excess activated sludge by the membrane-filtered water W₂ can be reduced.

The first treatment step S11 is preferably performed in the membrane separation methane fermentation tank 20a. In this way, in the present embodiment, the device used in the first treatment step S11 can be made compact and reduced in construction cost as compared with the activated sludge method in the related art. In addition, since it is unnecessary to perform aeration with a large amount of oxygen (air) as in the activated sludge method, the running cost can be reduced. The membrane separation methane fermentation tank 20a can be a methane fermentation tank that retains suspended anaerobic bacteria (including methanogenic archaea) or a methane fermentation tank that retains anaerobic granular sludge.

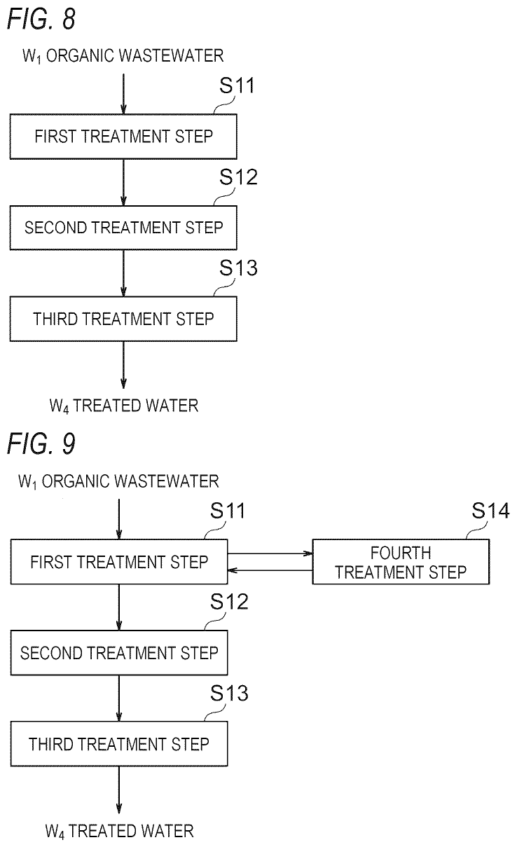

In addition, as illustrated in FIG. 9, the first treatment step S11 preferably includes a fourth treatment step S14 of removing generated CO₂. The fourth treatment step S14 can be performed by the fourth treatment device 25 in the organic wastewater treatment apparatus 100. Therefore, since CO₂ is removed by performing the fourth treatment step S14, it is possible to prevent pH in the first treatment step S11 (methane fermentation) from decreasing to 6.5 or less and to make it difficult to decrease the pH of the membrane-filtered water. Therefore, it is easy to adjust the pH of the obtained membrane-filtered water to a range of pH of 7 to 8.5 suitable for the anammox reaction performed in the subsequent third treatment step S13.

### (Second Treatment Step S12)

The second treatment step S12 is a methane recovery step of recovering dissolved methane.

In the second treatment step, methane dissolved in the membrane-filtered water W₂ is recovered by using a vacuum degassing device including the closing part 31a that closes an upper portion of the second treatment tank illustrated in FIG. 2A to bring the second treatment tank into a sealed state, the degassing outer cylinder 33 that is erected in a vertical axis direction on an upper side of the closing part 31a, the inner cylinder 34 having one end 34a disposed in the membrane-filtered water W₂ inside the degassing outer cylinder 33 and the other end 34b disposed in the upper gas reservoir S inside the degassing outer cylinder 33, and the methane recovery line L₁₂ connected to a top portion 33a of the degassing outer cylinder 33 and having the vacuum pump VP interposed therein.

### (Third Treatment Step S13)

This is a step of denitrifying the nitrogen component contained in the membrane-filtered water by an anaerobic ammonium oxidation reaction (anammox reaction). The third treatment step S13 can be performed by the third treatment device 40 in the organic wastewater treatment apparatus 100. At this time, a part of NH₄—N contained in the membrane-filtered water can be oxidized with ammonium oxidation bacteria to produce NO₂—N as necessary. In the present embodiment, since it is only necessary to convert about half of NH₄—N into NO₂—N, the air amount to be brought into contact can be reduced to about half as compared with a reaction of nitrifying the total amount of NH₄—N into NO₂—N in the activated sludge method in the related art. Therefore, as described above, in the present embodiment, the aeration power, the amount of electricity, and the like required to nitrify NH₄—N into NO₂—N can be reduced to about half.

The third treatment step S13 is preferably performed in the single-tank type anammox tank 41. When the single-tank type anammox tank 41 is used, space saving and reduction in construction cost can be implemented as compared with a double-tank type anammox tank.

In the organic wastewater treatment method according to the present embodiment described above, the organic substance is subjected to methane fermentation, and membrane filtration is performed to obtain membrane-filtered water in the first treatment step S1 as described above. Since the organic substance is decomposed into methane (CH₄) and carbon dioxide (CO₂) by methane fermentation, the concentration of the organic substance contained in the membrane-filtered water can be reduced. Note that, since filtration is performed by membrane filtration, there is no floating substance contained. Therefore, the generation amount of excess activated sludge by the membrane-filtered water can be reduced in the subsequent third treatment step S13. On the other hand, the membrane-filtered water treated in the first treatment step S1 often contains a large amount of NH₄—N, but in the third treatment step S13, NH₄—N can be subjected to partial nitrification, and about half of NH₄—N can be converted into NO₂—N. Further, in the third treatment step S13, N2 is produced from NH₄—N and NO₂—N by anammox bacteria. In the organic wastewater treatment method according to the present embodiment, the air amount to be used in the partial nitrification can be reduced to about half of a reaction in the activated sludge method in the related art in which the total amount of NH₄—N is nitrified to NO₂—N. Therefore, in the present embodiment, the aeration power, the amount of electricity, and the like required to nitrify NH₄—N into NO₂—N can be reduced to about half. That is, the energy consumption can be reduced by the organic wastewater treatment method according to the present embodiment. In addition, as described above, the membrane-filtered water treated in the first treatment step S1 contains almost no organic substances or floating substances, and thus accordingly, the denitrifying bacteria, which are heterotrophic bacteria, are less likely to proliferate in the third treatment step S13, and the generation amount of excess activated sludge can be reduced.

At this time, since the dissolved methane in the membrane-filtered water W₂ can be recovered by the second treatment step S2 between the first treatment step S1 and the third treatment step S13, the recovery rate as biogas increases.

As described above, according to the present invention, it is possible to provide an organic wastewater treatment apparatus and an organic wastewater treatment method for reducing an amount of methane dissolved in membrane-filtered water and increasing a recovery amount of methane when organic wastewater is subjected to anaerobic treatment in a membrane separation methane fermentation tank.

### INDUSTRIAL APPLICABILITY

The present invention is applicable to organic wastewater treatment apparatuses and organic wastewater treatment methods in general.

### REFERENCE SIGNS LIST

100 (100A to 100E) organic wastewater treatment apparatus
10 flow rate adjustment tank
20 first treatment device
20a membrane separation methane fermentation tank
21 (integrated) immersion anaerobic MBR
25 fourth treatment device
30 second treatment device
31 second treatment tank
31a closing part
32 vacuum degassing device
33 degassing outer cylinder (outer cylinder)
34 inner cylinder
34a one end
34b other end
40 third treatment device
41 single-tank type anammox tank (anammox tank)
42 carrier
43 reaeration tank
61 sludge
62 dehydration device
63 dehydrated sludge
71 integrated tank
80 biological membrane filtration device
81 filling layer
S11 first treatment step
S12 second treatment step
S13 third treatment step
S14 fourth treatment step
B₁, B₂, B₃ blower
G, G₁, G₂ biogas (methane)
L₁ inflow line
L₂ to L₅ drain line
L₆ outflow line
L₈ sludge return line
L₇, L₉ sludge discharge line
L₁₁ biogas discharge line
L₁₂ methane recovery line
L₁₃ gas return line
P₁ to P₆ pump
VP, VP₁ vacuum pump
S upper gas reservoir
W₁ organic wastewater
W₂ membrane-filtered water
W₃ methane-removal-treated water
W₄: treated water
W₅ discharge water

1. An organic wastewater treatment apparatus comprising:
a first treatment device configured to perform methane fermentation on organic wastewater containing a floating substance, an organic substance, and a nitrogen component under an anaerobic condition and perform membrane filtration to obtain membrane-filtered water;
a second treatment device provided downstream of the first treatment device and including a vacuum degassing device that removes and recovers a part of dissolved methane in the membrane-filtered water; and
a third treatment device provided downstream of the second treatment device and configured to perform post-treatment, wherein
the vacuum degassing device includes a closing part that closes an upper gas phase section of a second treatment tank to bring the second treatment tank into a sealed state, a degassing outer cylinder erected in a vertical axis direction on an upper side of the closing part, an inner cylinder having one end disposed in the membrane-filtered water inside the degassing outer cylinder and the other end disposed in an upper gas reservoir inside the degassing outer cylinder, and a methane recovery line connected to a top portion of the degassing outer cylinder and having a vacuum pump interposed therein.

2. (canceled)

3. The organic wastewater treatment apparatus according to claim 1, wherein
a vacuum degree of the vacuum degassing device is 10 kPa to 50 kPa.

4. The organic wastewater treatment apparatus according to claim 1, wherein
the first treatment device includes a fourth treatment device that removes generated carbon dioxide.

5. The organic wastewater treatment apparatus according to claim 1, wherein
the first treatment device is a membrane separation methane fermentation tank.

6. The organic wastewater treatment apparatus according to claim 1, wherein
a membrane separation methane fermentation tank and a second treatment tank of the second treatment device are formed as an integrated tank, and a partition wall that partitions the organic wastewater and the membrane-filtered water is provided.

7. The organic wastewater treatment apparatus according to claim 5, wherein
the membrane separation methane fermentation tank is a methane fermentation tank that retains suspended anaerobic bacteria or a methane fermentation tank that retains anaerobic granular sludge.

8. The organic wastewater treatment apparatus according to claim 1, wherein
the third treatment device is
an anammox treatment tank in which an anaerobic ammonium oxidation reaction is performed in an anammox tank to denitrify the nitrogen component contained in methane-removal-treated water obtained by recovering and removing a part of the dissolved methane from the membrane-filtered water.

9. The organic wastewater treatment apparatus according to claim 1, wherein
the third treatment device is
an aeration treatment tank that aerates methane-removal-treated water obtained by recovering and removing a part of the dissolved methane from the membrane-filtered water.

10. The organic wastewater treatment apparatus according to claim 1, wherein
the third treatment device is
a biological membrane filtration tank that performs biological membrane filtration on methane-removal-treated water obtained by recovering and removing a part of methane from the membrane-filtered water.

11. An organic wastewater treatment method, comprising:
a first treatment step of performing methane fermentation on organic wastewater containing a floating substance, an organic substance, and a nitrogen component under an anaerobic condition and performing membrane filtration to obtain membrane-filtered water;
a second treatment step including a vacuum degassing device that removes and recovers a part of dissolved methane in the membrane-filtered water obtained in the first treatment step; and
a third treatment step of performing post-treatment on treated water obtained in the second treatment step, wherein
in the second treatment step,
the vacuum degassing device includes a closing part that closes an upper portion of a second treatment tank to bring the second treatment tank into a sealed state, a degassing outer cylinder erected in a vertical axis direction on an upper side of the closing part, an inner cylinder having one end disposed in the membrane-filtered water inside the degassing outer cylinder and the other end disposed in an upper gas reservoir inside the degassing outer cylinder, and a methane recovery line connected to a top portion of the degassing outer cylinder and having a vacuum pump interposed therein, and recovers the dissolved methane in the membrane-filtered water at a predetermined vacuum degree.

12. (canceled)

13. The organic wastewater treatment method according to claim 11, wherein
the vacuum degree of the vacuum degassing device is 10 kPa to 50 kPa.

14. The organic wastewater treatment method according to claim 11, wherein
the first treatment step includes a fourth treatment step of removing generated carbon dioxide.

15. The organic wastewater treatment method according to claim 11, wherein
the first treatment step is performed in a membrane separation methane fermentation tank.

16. The organic wastewater treatment method according to claim 15, wherein
the membrane separation methane fermentation tank is a methane fermentation tank that retains suspended anaerobic bacteria or a methane fermentation tank that retains anaerobic granular sludge.

17. The organic wastewater treatment method according to claim 11, wherein
the third treatment steep is
an anammox treatment step of denitrifying the nitrogen component contained in methane-removal-treated water obtained by recovering and removing a part of the dissolved methane from the membrane-filtered water by ammonia oxidation bacteria, anammox bacteria, and denitrifying bacteria.

18. The organic wastewater treatment method according to claim 11, wherein
the third treatment step is
an aeration treatment step of aerating methane-removal-treated water obtained by recovering and removing a part of the dissolved methane from the membrane-filtered water.

19. The organic wastewater treatment method according to claim 11, wherein
the third treatment step is
a biological membrane filtration step of performing biological membrane filtration on methane-removal-treated water obtained by recovering and removing a part of the dissolved methane from the membrane-filtered water.
